(19) United States
(12) Patent Application Publication
(10) Pub. No.: US 2002/0066608 A1
(43) Pub. Date: Jun. 6, 2002

(54) Electric powered vehicle with turbine generator

(76) Inventors: Edward F. Guenard, Coquitlam (CA); Yvan J.G. LeTemplier, Coquitlam (CA)

Correspondence Address: Paul W. Vapnek, Townsend and Townsend and Crew LLP, Two Embarcadero Center, Eighth Floor, San Francisco, CA, 94111-3834, US

(21) Appl. No.: 09/731,321

(22) Filed: Dec. 4, 2000

(51) Int. Cl. B60K 1/00

(52) U.S. Cl. 180/65.3

(57) ABSTRACT

An electric vehicle having an electric drive motor and an energy storage device to provide power for the motor uses a re-charge system to increase the range of the vehicle. The re-charge system comprises a turbine mounted to the vehicle for rotation in the air stream generated by forward movement of the vehicle. A generator of electrical current is driven by the turbine for trickle charging the energy storage device while the vehicle is in motion.

### FIELD OF THE INVENTION

This invention relates generally to vehicles for transportation, and more particularly, to a vehicle powered by electricity that employs a wind-driven turbine to provide auxiliary power to charge on-board electric storage batteries.

### BACKGROUND OF THE INVENTION

The modern automobile powered by the internal combustion engine is a significant contributor to air pollution. In recent years, advances in technology relating to electric motors and electric storage batteries has made it feasible to produce vehicles that do not generate the pollutant gases of the internal combustion engine. Such electric vehicles still suffer from the drawback that they tend to have a limited range that is dictated by the storage capacity of the on-board batteries. Electric cars are still impractical because current battery technology limits the distance an electric car can travel before its battery must be recharged. This distance is currently less than 160 km (100 mi) in most cases, and the batteries take at least three hours to recharge. And accessories, such as air conditioning or radios, drain the battery even more quickly.

A partial solution to this problem is to include more on-board storage batteries, however, this increases the mass of the vehicle and hence the load that must be accelerated by the motor leading to an increased power drain on the motor. The greater range possible with additional batteries is quickly offset by the additional power needed to accelerate the mass of the additional batteries.

### SUMMARY OF THE INVENTION

To address the problem of increasing the range of electric vehicles, we have developed an electric vehicle that includes a battery charging system that makes use of a turbine powered by the air stream generated by movement of the vehicle.

Accordingly, the present invention provides, in an electric vehicle having an electric drive motor and an energy storage device to provide power for the motor, the improvement comprising:

a turbine mounted to the vehicle for rotation in the air stream generated by forward movement of the vehicle; and

a generator of electrical current driven by the turbine for charging the energy storage device.

In a further aspect, the present invention provides a charging system for an electric vehicle having an electric drive motor and an energy storage device to provide power for the motor, the charging system comprising:

a turbine mountable to the vehicle for rotation in the air stream generated by forward movement of the vehicle; and

a generator of electrical current drivable by the turbine to charge the energy storage device.

In a still further aspect, the present invention provides an electric vehicle comprising:

a chassis supported by rotatable wheels an electric drive motor to drive the wheels;

an energy storage device to provide power for the motor; and

a turbine mounted to the vehicle for rotation in the air stream generated by forward movement of the vehicle; and

a generator of electrical current driven by the turbine for charging the energy storage device.

### BRIEF DESCRIPTION OF THE DRAWINGS

Aspects of the present invention are illustrated, merely by way of example, in the accompanying drawings in which:

FIG. 1 is a side elevation view of an electric vehicle according to the present invention;

FIG. 2 is plan view of the electric vehicle showing banks of batteries;

FIG. 3 is a sectioned elevation view through the rear of the vehicle showing details of the air tunnel and the batteries;

FIG. 4 is a schematic view of the turbine and generators of the current invention; and

FIG. 5 is detail view of a preferred shroud for housing the turbine and generators.

### DESCRIPTION OF THE PREFERRED EMBODIMENTS

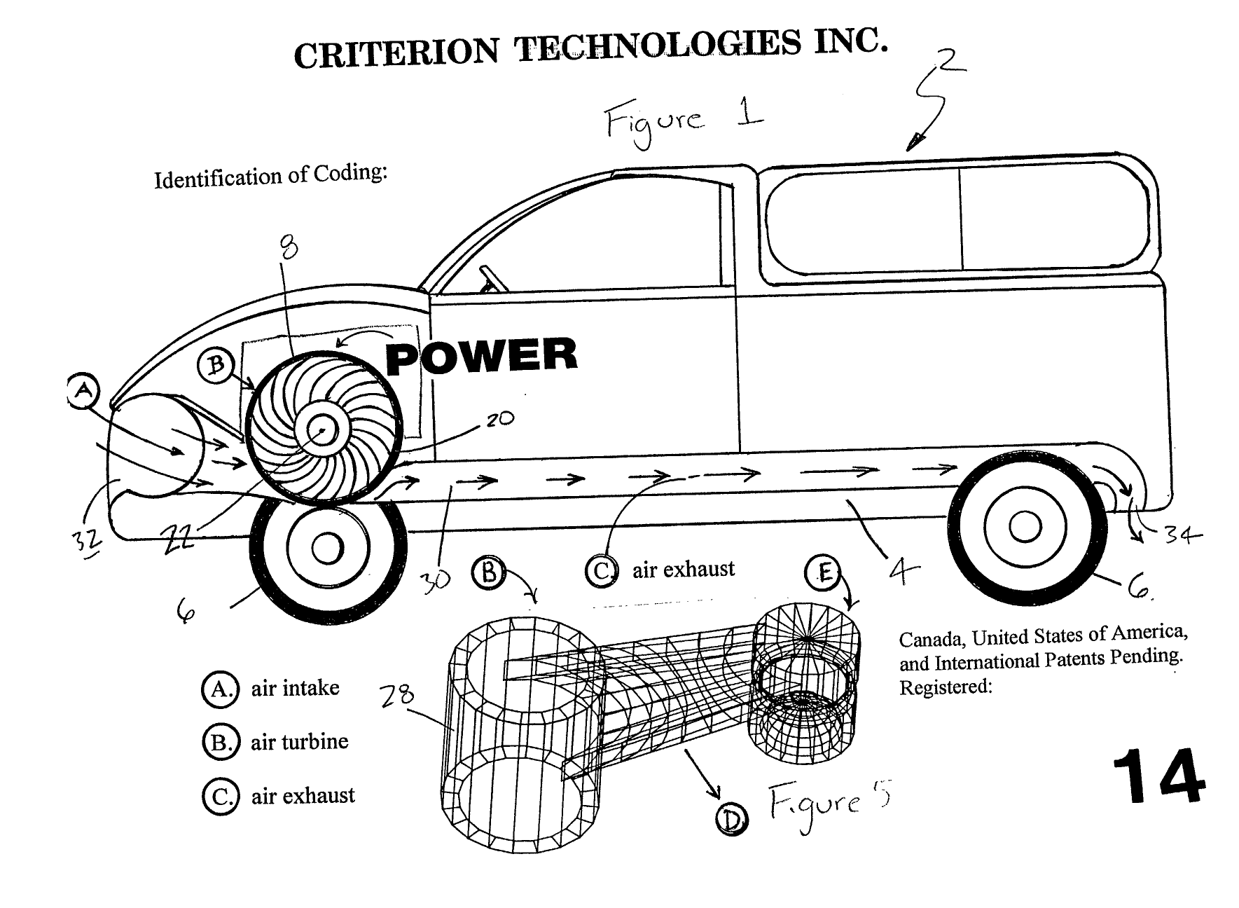

Referring to FIG. 1, there is shown an electric vehicle 2 according to a preferred embodiment of the present invention. The vehicle is conventional to the extent that it includes a chassis 4 supporting a body with passenger and luggage compartments. The chassis is supported by a series of rotatable wheels 6. An electric motor 8 is used to drive the wheels via a power train of gears, shafts, and joints that transmit motion from the motor to wheels. Motor 8 is preferably a series DC motor sized appropriately for the intended use of the vehicle. For example, a motor sized to produce 100 peak horsepower is appropriate for a conventional passenger vehicle and will permit acceleration from 0-80 kph in 9 seconds with a top governed speed of 120 kph.

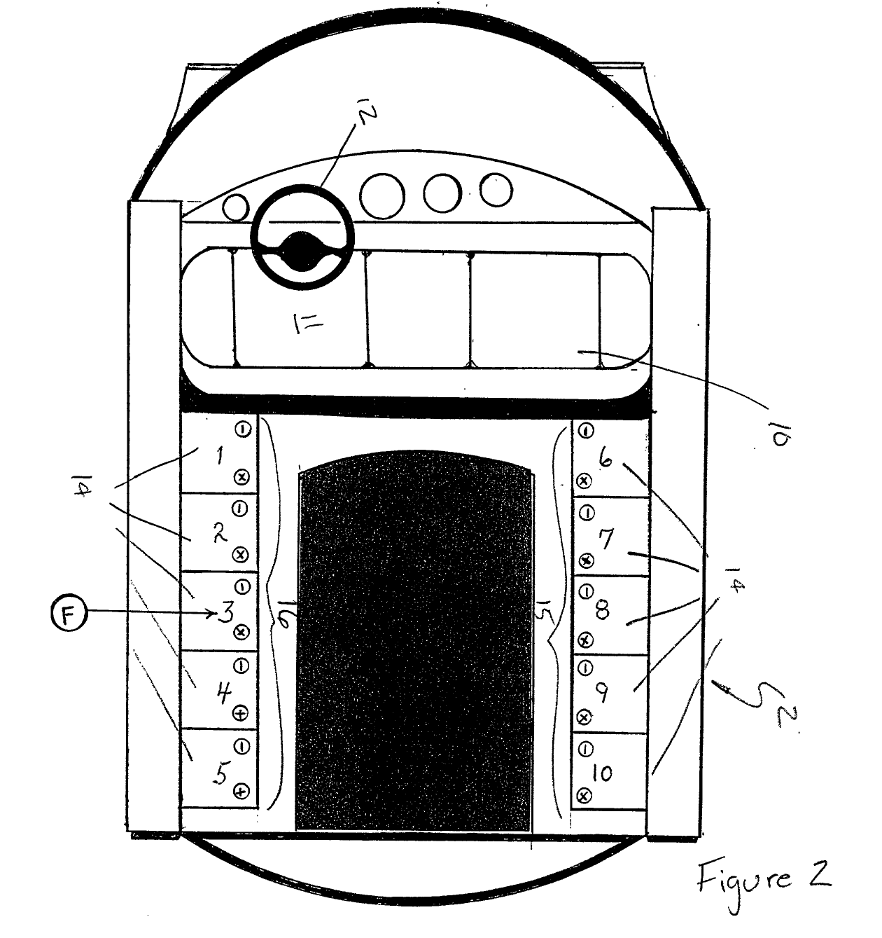

As best shown in FIG. 2, the vehicle is controlled by a driver seated on seats 11 in passenger compartment 10. Steering wheel 12 is used to control the direction of the vehicle. An accelerator and brake pedal (not shown) are provided to control the speed of the vehicle.

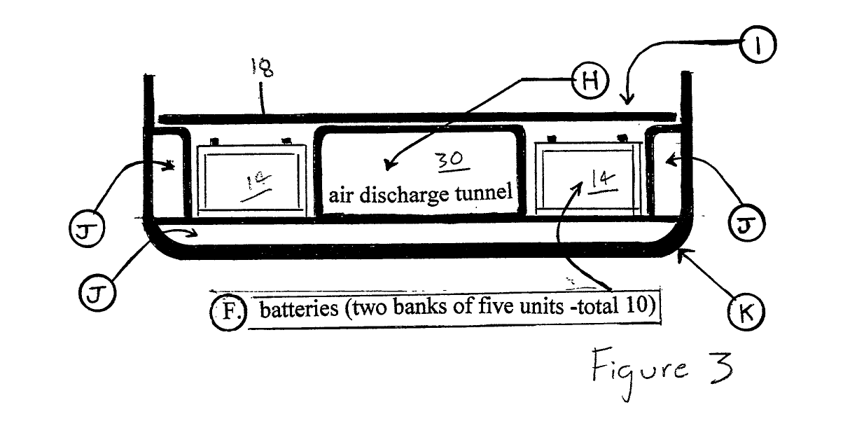

Energy storage devices in the form of one or more electric batteries 14 are used to provide power for the drive motor 10. The batteries are preferably arranged in banks 15 and 16 in the rear portion of the vehicle. The batteries are preferably 12 volt rechargeable units with five batteries per bank connected in series. As best shown in FIG. 3, which is a rear elevation view of the vehicle, the banks of batteries are stored below a raised floor 18. Floor 18 can support seats to accommodate additional passengers or can be left clear as a cargo area depending on the intend use of the vehicle.

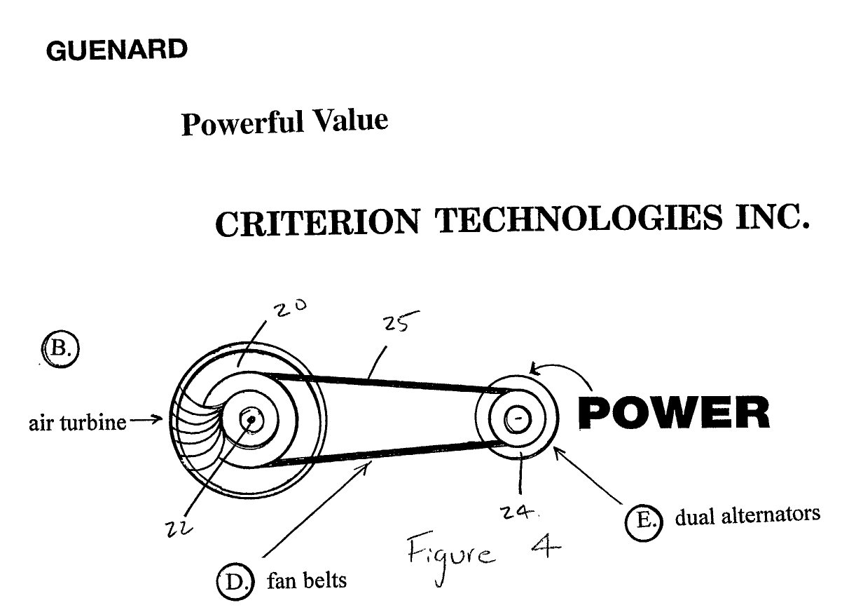

Referring to FIG. 1, the electric vehicle of the present invention is unique by virtue of a charging system that is provided to re-charge the batteries while the vehicle is in motion. The charging system includes a turbine 20 mounted to the vehicle for rotation in the air stream generated by forward movement of the vehicle. Turbine 20 is preferably a cylindrical stainless steel unit mounted for rotation about main shaft 22. Turbine 20 drives a generator 24 of electrical current via a belt drive 25 (FIG. 4). Preferably, generator 24 comprises a pair of alternators that convert the kinetic energy of the turbine into electric energy in the form of alternating current (AC). The alternating current is converted to direct current by a suitable rectifier and used to charge the batteries. Alternatively, generator 24 can comprises at least one DC generator which produces direct current. As best shown in FIG. 5, turbine 20, generators 24 and belt drive 25 are preferably housed within a enclosing shroud 28.

Charging of the batteries occurs whenever the vehicle is travelling at a speed sufficient to generate an air stream capable of rotating turbine 20. When generators 24 are producing charging current, the current is used to charge one of the banks 15 or 16 of batteries. The other non-charging bank is used to drive the electric motor. As a bank of batteries is fully recharged, the charging current is automatically switched to the other bank, and the fully re-charged bank assumes the role of providing power for the electric motor.

The charging system of the present invention works in conjunction with the regenerative braking system found in most conventional electric vehicles which uses the braking system as a battery charger. When drivers take their feet from the accelerator, the motor acts as a generator and converts the energy caused by the movement of the vehicle back into electricity for storage in the battery.

To ensure the most efficient generation of charging current by turbine 20, the electric vehicle is preferably formed with an air tunnel 30 to direct air past turbine 20 as shown in FIG. 1. Air tunnel 30 has an inlet 32 at the front of the vehicle and extends through the floor of the vehicle between the battery banks 15 and 16 (FIG. 3) to an outlet 34 toward the rear of the vehicle. Turbine 20 is mounted at the front of the vehicle within air tunnel 30. Air enters inlet 32 as the vehicle moves forward and is accelerated past turbine 20 to generate electricity.

The vehicle and charging system of the present invention permit automatic charging of the batteries of the vehicle whenever the vehicle travels at sufficient speed to rotate the turbine. The result is that the effective range of the vehicle is extended.

Although the present invention has been described in some detail by way of example for purposes of clarity and understanding, it will be apparent that certain changes and modifications may be practised within the scope of the appended claims.

I claim:

1. In an electric vehicle having an electric drive motor and an energy storage device to provide power for the motor, the improvement comprising:
a turbine mounted to the vehicle for rotation in the air stream generated by forward movement of the vehicle; and
a generator of electrical current driven by the turbine for charging the energy storage device.

2. An electric vehicle as claimed in claim 1 in which the generator of electrical current comprises at least one alternator that generates AC current.

3. An electric vehicle as claimed in claim 1 in which the generator of electrical current comprises at least one DC generator.

4. An electric vehicle as claimed in claim 1 in which the energy storage device comprises at least one battery.

5. An electric vehicle as claimed in claim 1 in which the energy storage device comprises a plurality of batteries arranged into two sets with the generator charging one set at a time, the non-charging set being used to drive the electric motor.

6. An electric vehicle as claimed in claim 1 including an air tunnel having an inlet at the front of the vehicle and an outlet toward the rear of the vehicle, the air tunnel housing the turbine so that air is directed past the turbine.

7. An electric vehicle comprising:
a chassis supported by rotatable wheels
an electric drive motor to drive the wheels;
an energy storage device to provide power for the motor; and
a turbine mounted to the vehicle for rotation in the air stream generated by forward movement of the vehicle; and
a generator of electrical current driven by the turbine for charging the energy storage device.

8 An electric vehicle as claimed in claim 7 in which the generator of electrical current comprises at least one alternator that generates AC current.

9. An electric vehicle as claimed in claim 7 in which the generator of electrical current comprises at least one DC generator.

10. An electric vehicle as claimed in claim 7 in which the energy storage device comprises at least one battery.

11. An electric vehicle as claimed in claim 7 in which the energy storage device comprises a plurality of batteries arranged into two sets with the generator charging one set at a time, the non-charging set being used to drive the electric motor.

12. An electric vehicle as claimed in claim 7 including an air tunnel having an inlet at the front of the vehicle and an outlet toward the rear of the vehicle, the air tunnel housing the turbine so that air is directed past the turbine.

13. A method for charging an electric vehicle having an electric drive motor and an energy storage device to provide power for the motor, comprising the steps of:
providing a turbine mounted to the vehicle to drive a generator of electrical current;
advancing the vehicle in a forward direction at sufficient speed to generate an air stream to rotate the turbine and drive the generator of electrical current to charge the energy storage device.

14. A method as claimed in claim 13 in which the energy storage device comprises a plurality of batteries arranged into two sets, and the generator charges one set at a time, the non-charging set being used to power the electric motor.

15. A charging system for an electric vehicle having an electric drive motor and an energy storage device to provide power for the motor, the charging system comprising:
a turbine mountable to the vehicle for rotation in the air stream generated by forward movement of the vehicle; and
a generator of electrical current drivable by the turbine to charge the energy storage device.
